(19) United States
(12) Patent Application Publication
(10) Pub. No.: US 2025/0246328 A1
(43) Pub. Date: Jul. 31, 2025

(54) ANNULAR TARGET AND TARGET HOLDER FOR A RADIATION DELIVERY SYSTEM

(71) Applicant: QSA Global Inc., Burlington, MA (US)

(72) Inventors: David Wood, Waltham, MA (US); Brian Girouard, Billerica, MA (US)

(21) Appl. No.: 19/038,930

(22) Filed: Jan. 28, 2025

Related U.S. Application Data
(60) Provisional application No. 63/626,140, filed on Jan. 29, 2024.

(51) Int. Cl. G21F 5/015; G21F 5/10

(52) U.S. Cl. CPC G21F 5/015; G21F 5/10

(57) ABSTRACT

Example systems and devices for housing radioactive targets are provided. The systems and methods support and arrange radioactive targets for radiation delivery process in a radiation delivery system. In some examples, a system for housing radioactive targets includes an annular core configured to support one or more targets in one or more recesses arranged on an external surface of the annular core; and a cylindrical sleeve configured to enclose the annular core, wherein an inner diameter of the cylindrical sleeve is greater than an outer diameter of the annular core.

### CROSS REFERENCE TO RELATED APPLICATIONS

This application is a Non-Provisional Patent Application claiming priority to U.S. Provisional Patent Application No. 63/626,140 entitled “Annular Target And Target Holder For A Radiation Delivery System” filed Jan. 29, 2024, which is herein incorporated by reference in its entirety.

### FIELD OF THE DISCLOSURE

This disclosure relates generally to systems and devices for housing radioactive targets and, more particularly, to systems and devices to support and arrange radioactive targets for radiation delivery process in a radiation delivery system.

### BACKGROUND

Radioisotope sources, such as radioactive disks, are useful in a variety of industrial application. A radioisotope projector can be used to detect structural damage to metal parts, for example. Irradiation of such radioisotope sources requires specialized equipment and training, and can be a costly process. Further, transportation of irradiated sources requires specific procedures be followed, and specialized containment equipment used to handle and transport the radioisotope sources. Thus, systems and devices that reduce costs associated with irradiation of radioisotope sources and transportation thereof is desirable.

### SUMMARY

Systems and devices for housing radioactive targets are disclosed, substantially as illustrated by and described in connection with at least one of the figures, as set forth more completely in the claims.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates an example target assembly, in accordance with aspects of this disclosure.

FIGS. 1A to 1D illustrate alternative views of example target assemblies, in accordance with aspects of this disclosure.

FIGS. 2A to 2D illustrate profiles of example target assemblies, in accordance with aspects of this disclosure.

FIGS. 3A to 3E illustrate perspective views of an example target support, in accordance with aspects of this disclosure.

FIGS. 4A to 4E illustrate profiles of example target supports, in accordance with aspects of this disclosure.

The figures are not necessarily to scale. Wherever appropriate, similar or identical reference numerals are used to refer to similar or identical components.

### DETAILED DESCRIPTION

Disclosed systems and devices for housing radioactive targets and, more particularly, to systems and methods support and arrange radioactive targets for radiation delivery process in a radiation delivery system. In some examples, a system for housing radioactive targets includes an annular core configured to support one or more targets in one or more recesses arranged on an external surface of the annular core; and a cylindrical sleeve configured to enclose the annular core, wherein an inner diameter of the cylindrical sleeve is greater than an outer diameter of the annular core.

Additionally or alternatively, an example support for targets in a radiation delivery system is disclosed. The radiation delivery system includes a central rod having one or more cooling channels extending through a portion of the central rod; a manipulator interface for mounting the support into the radiation delivery system; and a loading end to serve as a backstop for one or more target assemblies, wherein the loading end of the central rod is defined by an external diameter that is greater than an internal diameter of the one or more target assemblies.

Radioisotope sources, such as Iridium-192 (Ir-192), are used as a source of gamma radiation for industrial applications, including industrial gamma radiography on materials such as castings, forgings, and weld defects. Suitable materials include concrete, steel, lead, tungsten, or others.

Natural and enriched Iridium-192 sources are constructed using iridium targets (e.g., metal discs or pellets, often of a uniform size), and housed and/or transported in a welded stainless steel capsule. Moreover, utilizing enriched Ir-192 produces smaller focal sizes for optimum image quality for industrial imaging processes.

Handling, housing, transporting, and irradiating an iridium target requires specialized techniques and equipment. In some examples, irradiating an iridium target (or a plurality of targets) is performed in a radiation delivery system. The system retains the inactive iridium in an arrangement which more efficiently exposes the iridium to neutron radiation, which activates the iridium contained within the target to result in a higher yield of Ir-192, the desired isotope.

Processing of loose (i.e. individual disks) radioactive Ir-192 can cause a contamination risk to operators. Thus, specialized facilities and equipment are required to handle loose radioactive material. Many reactor operators work in facilities and with equipment that are not equipped to properly process loose Ir-192. The disclosed design is part of a system which allows a reactor operator to expose bulk iridium to activating neutron radiation and properly transport the active material to a secondary facility for further processing without needing to handle loose radioactive material. Moving the loose material processing to a secondary facility increases the number of reactors which can activate iridium.

To increase the efficiency of such an operation, disclosed are target assemblies that increase a number of targets that can be arranged around an outer diameter of a target core. Multiple examples are provided, with specific features which may offer benefits for different applications. Further, the target assemblies can be arranged on a support configured for insertion in the radiation delivery system. The target assemblies and support maximize the number of targets being irradiated in a single radiation delivery operation, as well as provide enhanced and/or expanded cooling options during such an operation. Moreover, the target assemblies can be stored within a special form capsule while each target is separately mounted on the target core, resulting in a straightforward process and system to package, handle and/or transport the targets. Moreover, the target assemblies 100 can be removed from the target support 300 and transferred to a special form capsule while maintaining containment of the radioactive material. Each target is separately mounted on the target support, resulting in a straightforward process and system to package, handle and/or transport the targets.

In disclosed examples, a system for housing radioactive targets includes an annular core configured to support one or more targets in one or more recesses arranged on an external surface of the annular core; and a cylindrical sleeve configured to enclose the annular core, wherein an inner diameter of the cylindrical sleeve is greater than an outer diameter of the annular core.

In some examples, the one or more targets are formed as disks.

In examples, the one or more recesses are arranged in a pattern of alternating rows such that a vertical axis of a disc in a first row extends midway between vertical axes of discs in an adjacent second row.

In examples, the pattern of alternating rows results in a uniform distribution of the one or more targets about an external surface of the annular core.

In examples, the one or more recesses are arranged in a variable pattern.

In some examples, a wall of the annular core has a thickness greater than a thickness of the one or more targets.

In examples, when the one or more targets are inserted into the one or more recesses edges of the one or more targets remain within the outer diameter of the annular core.

In some examples, the annular core or the cylindrical sleeve are formed of a metallic material.

In examples, the metallic material comprises aluminum or graphite.

In some examples, the system further includes a weld to fix a position of the cylindrical sleeve over the annular core.

In some examples, the system further includes a device to fix a position of the cylindrical sleeve over the annular core.

In some disclosed examples, a support for targets in a radiation delivery system includes a central rod comprising: one or more cooling channels extending through a portion of the central rod; a manipulator interface for mounting the support into the radiation delivery system; and a loading end to serve as a backstop for one or more target assemblies, wherein the loading end of the central rod is defined by an external diameter that is greater than an internal diameter of the one or more target assemblies.

In some examples, the cooling chamber is fluidly connected to one or more openings at the mounting end or the loading end, the cooling chamber to receive a cooling fluid during a radiation delivery operation.

In some examples, the outer diameter of the central rod is consistent along the length between the manipulator interface and the loading end.

In some examples, the manipulator interface comprises a radial cap having a first outer diameter.

In examples, each of the one or more target cores are encased in a target sleeve, a portion of the radial cap having a first outer diameter greater than a second outer diameter of the target sleeve.

In examples, a length of the central rod between the manipulator interface and the loading end is at least twice a length of the one or more target cores.

For the purpose of promoting an understanding of the principles of the claimed technology and presenting its currently understood, best mode of operation, reference will be now made to the embodiments illustrated in the drawings and specific language will be used to describe the same. It will nevertheless be understood that no limitation of the scope of the claimed technology is thereby intended, with such alterations and further modifications in the illustrated device and such further applications of the principles of the claimed technology as illustrated therein being contemplated as would typically occur to one skilled in the art to which the claimed technology relates.

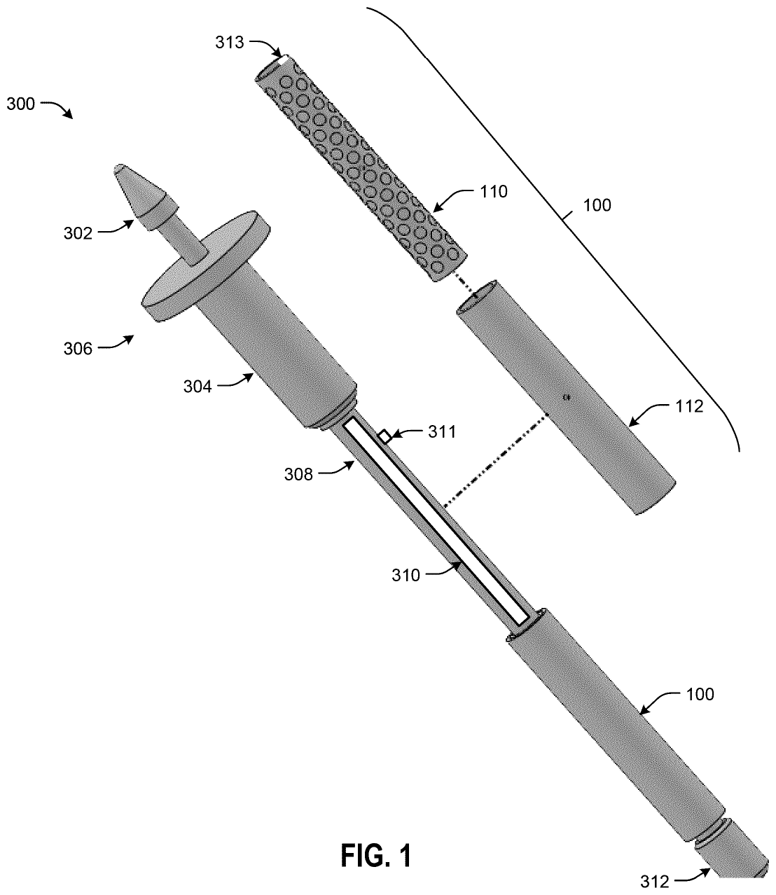

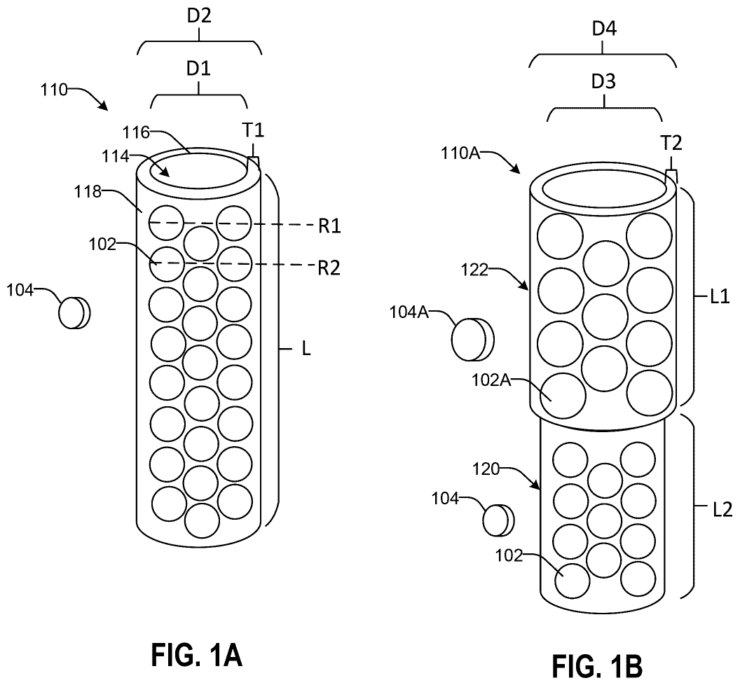

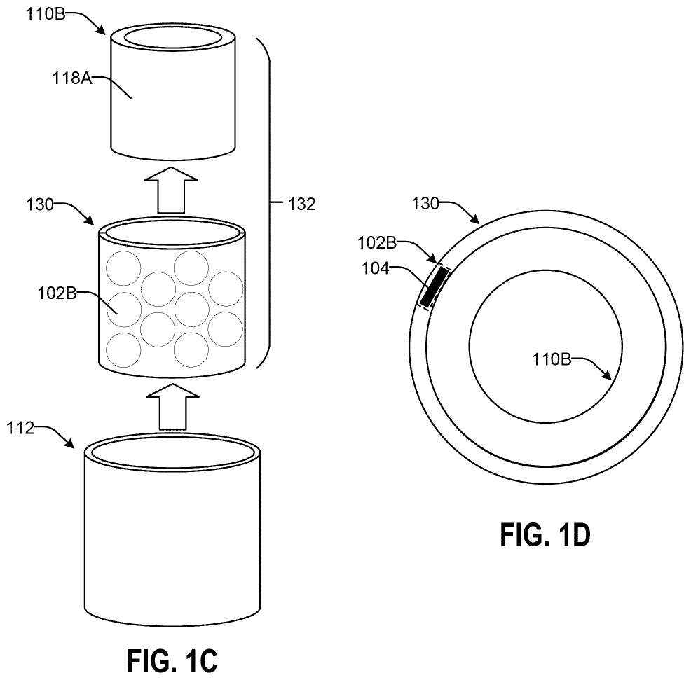

Turning to the figures, FIG. 1 illustrates an example target assembly 100 that includes a target core 110 designed to fit within a target sleeve 112. Example target core 110, as shown in FIG. 1A, has a generally annular shape, with a central core 114 extending lengthwise through the target core 110, the central core 114 having an inner diameter D1. An external surface 118 of the target core 110 has an external diameter D2, with the difference between the inner diameter D1 and the outer diameter D2 generally corresponding to a wall thickness T1 of the target core 110.

The target core 110 has a plurality of recesses 102 designed to support a target 104. As shown in FIGS. 1-1B, one or more of the recesses 102 can be fitted with a target. The recesses 102 are arranged in one or more patterns about the external surface 118, designed to maximize a number of targets that can be supported by the target core 110. As shown, the recesses 102 are arranged in alternating rows such that a vertical axis of a recess or target in a first row R1 of recesses extends midway between vertical axes of a recess or target in an adjacent, second row R2.

Although the pattern of recesses is shown as repeating and generally consistent, in some examples one or more of the recesses and/or rows are arranged in a variable pattern. This can include different sizes or shapes of one or more of the recesses, alignment of adjacent recesses or rows of recesses, and or one or more filled in recesses.

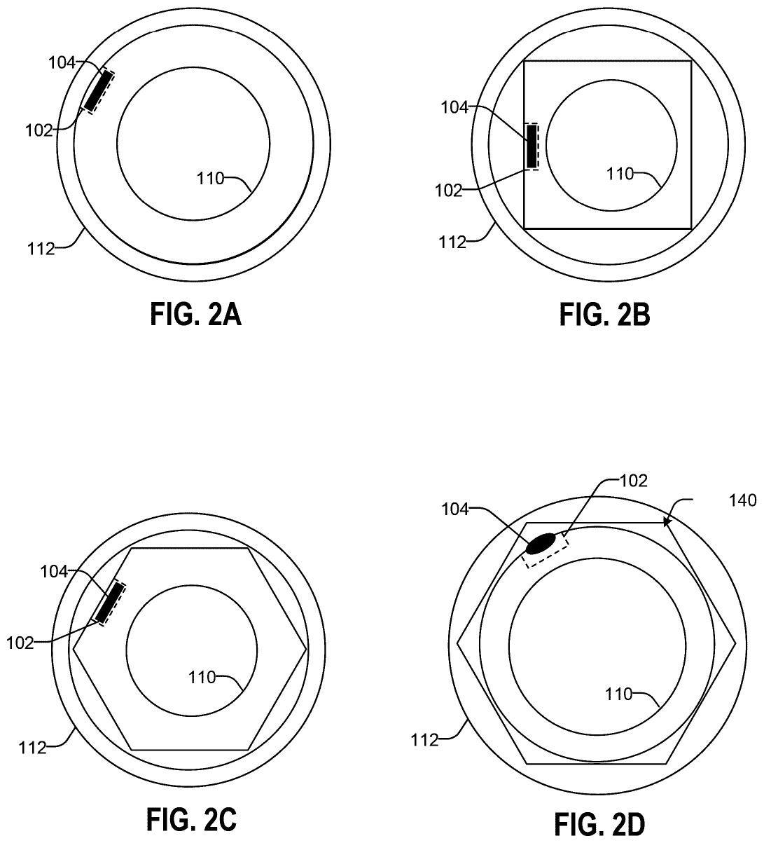

Although illustrated as having a consistent inner diameter and outer diameter (and therefor wall thickness) along the entire length L of the target core 110, in some examples the inner or outer diameter may change along one or more portions of the target core. In the example of FIG. 1B, a first portion 120 may have a first inner diameter D1 or outer diameter D2, with a second portion 122 having a second inner diameter D3 or second outer diameter D4, resulting in a wall thickness of T2. In some examples, the first inner diameter D1 is equal to the second inner diameter D3, such that the target core 110A fits onto rod 200 (as shown in FIG. 2). An inner diameter of the sleeve 112 could be modified with first and second portions to accommodate the diameters D2 and D4. The outer diameter of the sleeve 112 may reflect the modification, or could have a consistent diameter along a length of the sleeve 112.

Further, a length L1 of the first portion 120 may be equal to length L2 of the second portion 122. In some examples, the length L1 is greater than or smaller than the length L2. Moreover, the combined length of L1 and L2 may equal L, but may be longer or shorter.

The second portion 122 may further include recesses 102A that are larger or smaller than the recesses 102. For instance, the recesses 102A may be deeper and/or wider to accommodate a larger target 104A.

In the example illustrated in FIG. 1C, a target support shell 130 can be employed to hold the targets 104. In particular, a target core 110B can be formed with a substantially smooth/consistent external surface 108A (e.g., no recesses are formed on the core). The target support shell 130 can be designed with one or more recesses 102B, such that as the target support shell 130 nests with target core 110B, the recesses 102B are present on an outer diameter of the combined target core 132.

The recesses 102B can be formed on target support shell 130 as holes through the shell walls, and/or be recesses that do not extend through the wall. Once the core has been inserted into the shell, targets are placed in the recesses 102B, and the combined core 132 can be inserted into the sleeve 112. FIG. 1D illustrates a cutaway section of the core 110B nested within target support shell 130. As shown, the recess 102B rests atop an external surface of the core 110B through the wall of the target support shell 130. The target 104 is entirely within the recess 102B, however in some examples one or more portions of the target 104 may extend beyond an external surface of the target support shell 130. This option is also considered for recesses 102 on core 110.

Although several examples may illustrate the target core, the target sleeve, and/or the target support shell as having a generally consistent internal and/or external diameter, in some examples one or more of the target core, the target sleeve, and/or the target support shell has a differently shaped cross-sectional profile. For instance, in addition to an annular profile, the tube may have a rectangular, triangular, hexagonal, or other geometric profile. In some examples, the profile has an irregular profile, such as with one flat surface, to accommodate a different size or shape of targets.

FIGS. 2A-2D illustrate additional or alternative cutaway profiles of an example assembly 100. As shown in FIG. 2A, target 104 is entirely within a recess 102 within the core 110 and enclosed by sleeve 112. In some examples, one or more portions of the target 104 may extend beyond an external surface of the core 110, which may be supported by one or more channels on the sleeve 112.

FIG. 2B illustrates an example assembly 100 with a substantially rectangular core 110. FIG. 2C illustrates an example assembly 100 with a substantially hexagonal core 110. FIG. 2D illustrates an example assembly 100 with a cylindrical core 110 surrounded by a sleeve with a hexagonal internal surface. As such, voids or channels 140 exist between the external surface of the core 110 and the internal diameter of the sleeve 112, allowing for a target 104 to extend beyond a surface of the core. Although illustrated as generally circular/annular/cylindrical, in some examples the sleeve 112 may have a shape and/or profile complementary to the different shapes or profiles of the core 110.

Although several examples may illustrate targets as being generally cylindrical disks, the targets may have any suitable geometry. For instance, one or more of the targets may be round, oval, cuboid, or any such geometry. Further, one or more targets may have an irregular shape. As such, one or more of the recesses may be formed to receive such a modified target, which may include a depth, width, shape, and/or orientation of the recess on the target core.

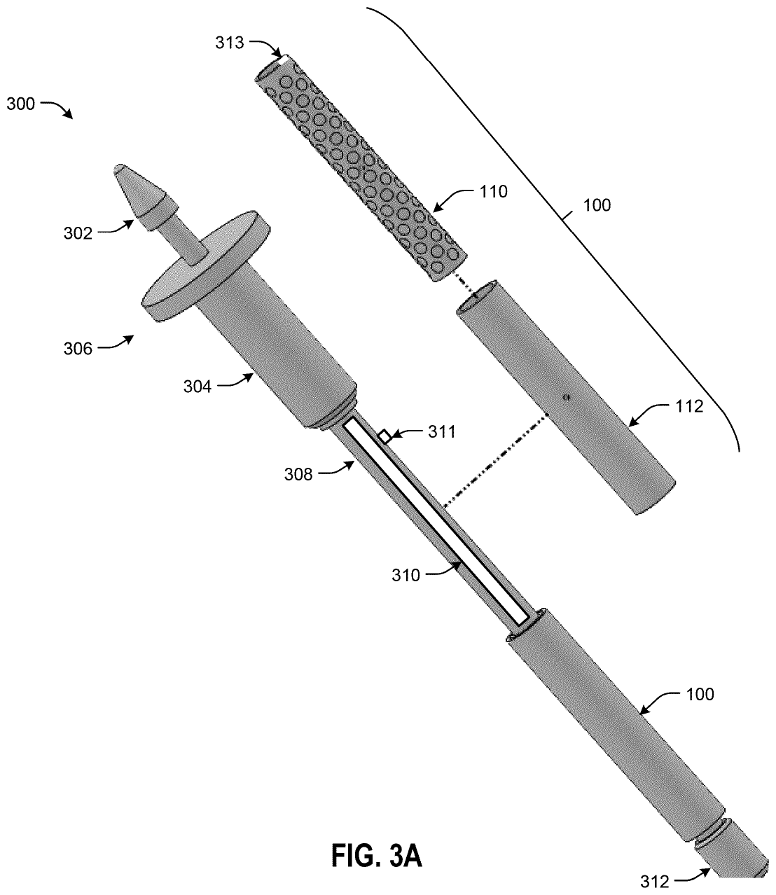

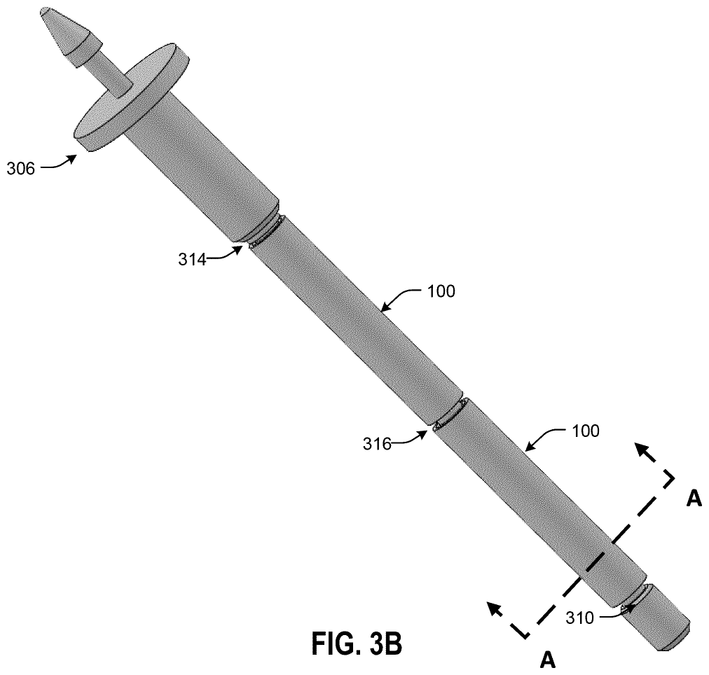

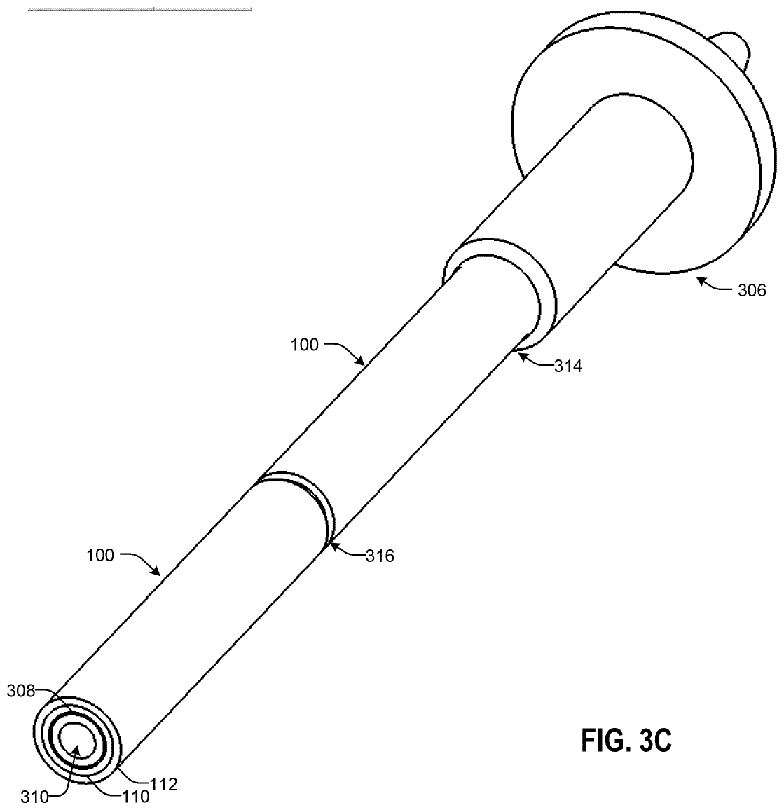

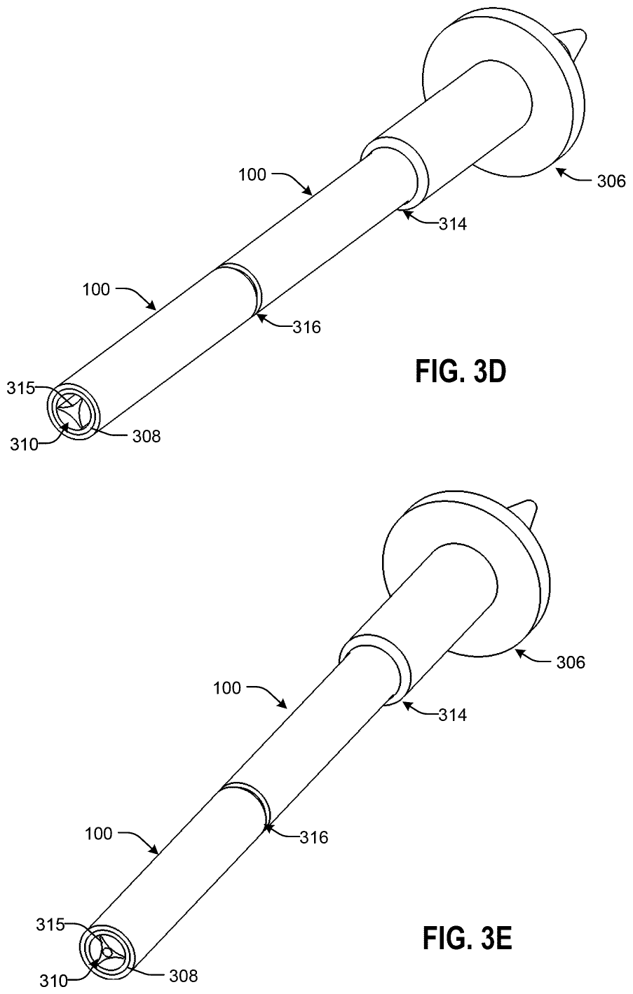

FIG. 3A illustrates an example support 300 for targets in a radiation delivery system. As shown, the support 300 includes a central rod 308 having one or more cooling channels 310 extending through a portion of the central rod. A first end 306 of the support includes a manipulator interface 306 and a radial cap 304 for manipulating the support 300, including maneuvering and inserting the support 300 into the radiation delivery system.

For example, opposite the first end 306 is a loading end that includes an end cap 312, which would be inserted into a chamber in the radiation delivery system. The cap 312 serves as a backstop for one or more target assemblies 100 mounted on the central rod 308. The central rod is defined by an external diameter that is less than an internal diameter of the one or more target assemblies, while the loading end 312 has a diameter equal to or greater than an internal diameter of the assemblies.

In some examples, all or part of the first end 306 can be removed to receive one or more assemblies 100. The assemblies could be fixed to the end cap 312, such as by a fastener, a weld, and/or the adjacent assembly and the end cap 312 could have complementary threaded surfaces. Although two assemblies 100 are shown mounted to support 300, a single assembly 100 can be mounted to the support 300, or three or more assemblies 100 may be so mounted (e.g., five, six, seven, eight, nine, ten, or more assemblies).

In the example of FIG. 3B, the joints 314, 316, and/or 318 could be floating joints, could have the assemblies fixed and/or fused (e.g., fastened, screwed, welded, bonded, etc.) together, could have the assemblies fixed and/or fused to the rod, and/or could have the assemblies fixed and/or fused to the first or second ends. In some examples, the rod 308 has a pin, extension, channel, or other device 311 to fix a radial orientation of an assembly mounted thereon (as shown in FIG. 3A). The core 110 may include a pin, extension, channel, or other device 313 complementary to device 311 that allows for mounting the assembly on the rod 308.

Although the manipulator interface 306 and/or the end cap 312 as having particular shapes and/or sizes in the illustrated examples, these figures are representative and do not limit the variety of shapes and/or sizes of these features.

FIGS. 3C-3E illustrate a perspective view of the support 300, with a cross-sectional view of the rod 308 and cooling channel 310 exposed along lines A-A shown in FIG. 3B. FIG. 3C illustrates the cooling channel 310 in the center of rod 308, surrounded by target core 110 and target sleeve 112.

FIGS. 3D and 3E illustrate perspective views of alternative supports, including a divider 315 centrally located within the cooling channel 310. In the example of FIG. 3E, the divider 315 has another channel bored through the center, which may be fluidly connected through a sidewall of the divider 315 at one or more places along a length of the rod 308.

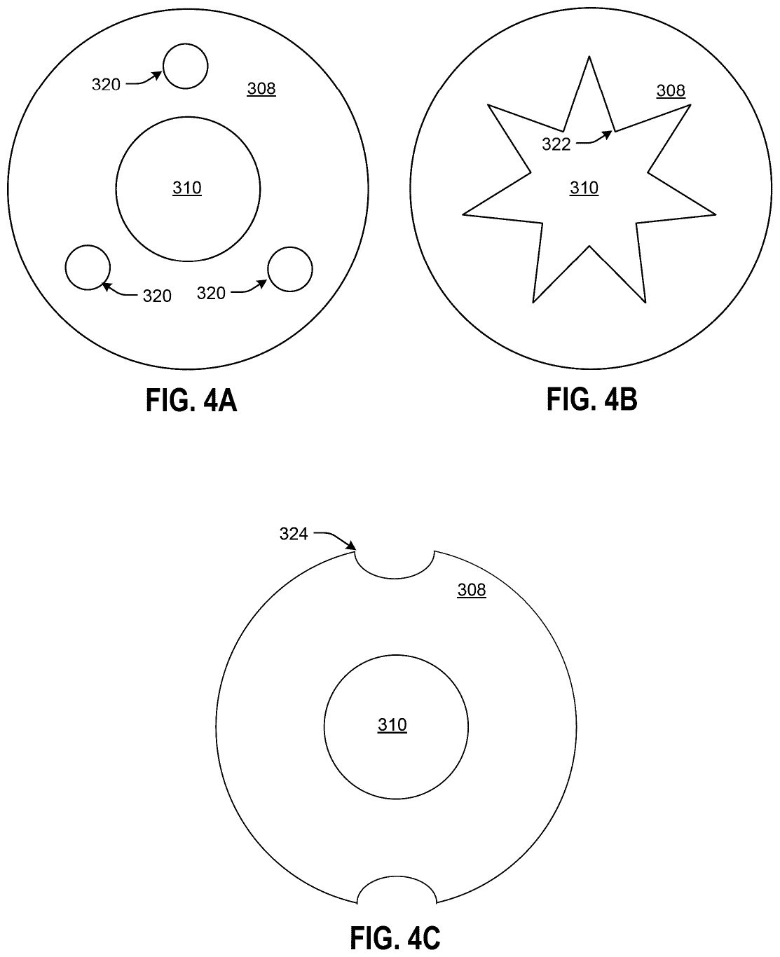

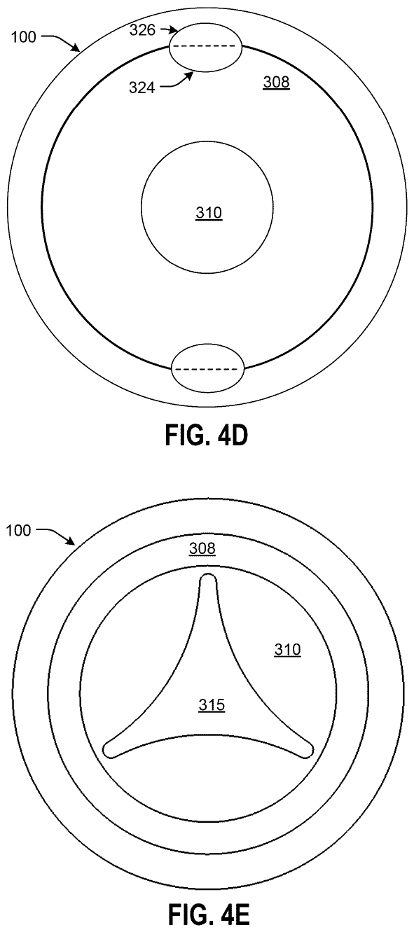

In some examples, the cooling channel 310 is coaxial with a central chamber within the rod 308. In additional or alternative examples, cooling elements can further enhance cooling and/or replace the cooling channel 310. The examples illustrated in FIGS. 4A-4E show cooling enhancements through the rod 308. FIG. 4A provides for one or more additional cooling channels 320 bored through a wall of the rod 308. FIG. 4B provides for one or more cooling fins 322 extending into the cooling channel 310. FIG. 4C provides for one or more surface cooling channels 324 extending along all or a part of the external surface of the wall of rod 308. Although the cooling channels 324 could be used separately, in some examples one or more complementary cooling channels 326 on an internal surface of the assembly 100 can be aligned with cooling channels 324 to create a larger fluid channel.

FIG. 4E illustrates an end view of the support shown in FIG. 3D, including divider 315 centrally located within the cooling channel 310. For example, the divider 315 may help direct fluid through the cooling channel 310, and/or serve as a heat sink or cooling fin during the radiation delivery process.

One or more of the cooling channels can be fluidly connected to one or more openings (e.g., at the mounting end or the loading end), the cooling chamber being configured to receive a cooling fluid during a radiation delivery operation.

Although several example cooling enhancements are provided separately in FIGS. 4-4D, in some examples two or more of the disclosed enhancements are formed together on the support 300.

One or more materials can be employed for the disclosed target assembly and/or the assembly support. For example, each of the annular core, the cylindrical sleeve, and the support can be formed of a metallic material, such as aluminum or titanium. In some examples, one or more of the features can be formed of graphite or a ceramic.

As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

While the present method and/or system has been described with reference to certain implementations, it will be understood by those skilled in the art that various changes may be made and equivalents may be substituted without departing from the scope of the present method and/or system. For example, block and/or components of disclosed examples may be combined, divided, re-arranged, and/or otherwise modified. In addition, many modifications may be made to adapt a particular situation or material to the teachings of the present disclosure without departing from its scope. Therefore, the present method and/or system are not limited to the particular implementations disclosed. Instead, the present method and/or system will include all implementations falling within the scope of the appended claims, both literally and under the doctrine of equivalents.

What is claimed is:

1. A system for housing radioactive targets comprising:
an annular core configured to support one or more targets in one or more recesses arranged on an external surface of the annular core; and
a cylindrical sleeve configured to enclose the annular core, wherein an inner diameter of the cylindrical sleeve is greater than an outer diameter of the annular core.

2. The system of claim 1, wherein the one or more targets are formed as disks.

3. The system of claim 2, wherein the one or more recesses are arranged in a pattern of alternating rows such that a vertical axis of a disc in a first row extends midway between vertical axes of discs in an adjacent second row.

4. The system of claim 3, wherein the pattern of alternating rows results in a uniform distribution of the one or more targets about an external surface of the annular core.

5. The system of claim 3, wherein the one or more recesses are arranged in a variable pattern.

6. The system of claim 1, wherein a wall of the annular core has a thickness greater than a thickness of the one or more targets.

7. The system of claim 6, wherein when the one or more targets are inserted into the one or more recesses edges of the one or more targets remain within the outer diameter of the annular core.

8. The system of claim 1, wherein the annular core or the cylindrical sleeve are formed of a metallic material.

9. The system of claim 8, wherein the metallic material comprises aluminum or graphite.

10. The system of claim 1, further comprising a weld to fix a position of the cylindrical sleeve over the annular core.

11. The system of claim 1, further comprising a device to fix a position of the cylindrical sleeve over the annular core.

12. A support for targets in a radiation delivery system comprising:
a central rod comprising:
one or more cooling channels extending through a portion of the central rod;
a manipulator interface for mounting the support into the radiation delivery system; and
a loading end to serve as a backstop for one or more target assemblies, wherein the loading end of the central rod is defined by an external diameter that is greater than an internal diameter of the one or more target assemblies.

13. The support of claim 12, wherein the cooling chamber is fluidly connected to one or more openings at the mounting end or the loading end, the cooling chamber to receive a cooling fluid during a radiation delivery operation.

14. The support of claim 12, wherein the outer diameter of the central rod is consistent along the length between the manipulator interface and the loading end.

15. The support of claim 12, wherein the manipulator interface comprises a radial cap having a first outer diameter.

16. The support of claim 15, wherein each of the one or more target cores are encased in a target sleeve, a portion of the radial cap having a first outer diameter greater than a second outer diameter of the target sleeve.

17. The support of claim 12, wherein a length of the central rod between the manipulator interface and the loading end is at least twice a length of the one or more target cores.
